(19) United States
(12) Patent Application Publication
(10) Pub. No.: US 2013/0085857 A1
(43) Pub. Date: Apr. 4, 2013

(54) CONVENIENCE-RELATED AND OTHER METRICS IN ADVERTISING

(71) Applicants: Eric Bax, Altadena, CA (US); Randall Lewis, San Jose, CA (US); Garrett Johnson, Evanston, IL (US); David Reiley, Berkeley, CA (US)

(72) Inventors: Eric Bax, Altadena, CA (US); Randall Lewis, San Jose, CA (US); Garrett Johnson, Evanston, IL (US); David Reiley, Berkeley, CA (US)

(73) Assignee: Yahoo! Inc., Sunnyvale, CA (US)

(21) Appl. No.: 13/249,704

(22) Filed: Sep. 30, 2011

(51) Int. Cl. G06Q 30/02

(52) U.S. Cl. 705/14.57

(57) ABSTRACT

Techniques are provided, for use in electronic or online advertising, that can be viewed as going beyond geographic proximity, including determination and use of convenience-based metrics in advertisement targeting, pricing, selection and packaging. For example, based on information including an actual or anticipated consumer location and a store location, one or more possible or likely consumer travel routes may be determined. Based at least in part on this, metrics, such as convenience-based metrics, can be determined and used in aspects of electronic or online advertising, such as consumer travel distance, travel time, or number or travel proximity of alternative stores.

### BACKGROUND

Geographic proximity of a consumer to a location at which a product is sold can obviously influence the consumer's likelihood to purchase the product at the location. Furthermore, research shows that geographic proximity can also influence a user's likelihood to make an online purchase, or respond positively to an associated electronic or online advertisement.

Geotargeting, and use of geographic factors in association with advertising such as online advertising, is known. However, while geographic proximity itself can be a very useful metric, a consumer's behavior may be influenced by factors, such as convenience-related factors, that go beyond just geographic proximity.

There is a need for techniques, such as techniques for use in electronic or online advertising, that utilize convenience-related and other metrics.

### SUMMARY

In some embodiments, techniques are provided, for use in electronic or online advertising, that can be viewed as going beyond geographic proximity, including determination and use of convenience-based metrics in advertisement targeting, pricing, selection and packaging. For example, based on information including an actual or anticipated consumer location and a store location, one or more possible or likely consumer travel routes may be determined. Based at least in part on this, metrics, such as convenience-based metrics, can be determined and used in aspects of electronic or online advertising, such as consumer travel distance, travel time, or number or travel proximity of alternative stores.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a method according to one embodiment of the invention;

FIG. 4 is a block diagram illustrating one embodiment of the invention; and

FIG. 5 is a block diagram illustrating one embodiment of the invention.

While the invention is described with reference to the above drawings, the drawings are intended to be illustrative, and the invention contemplates other embodiments within the spirit of the invention.

### DETAILED DESCRIPTION

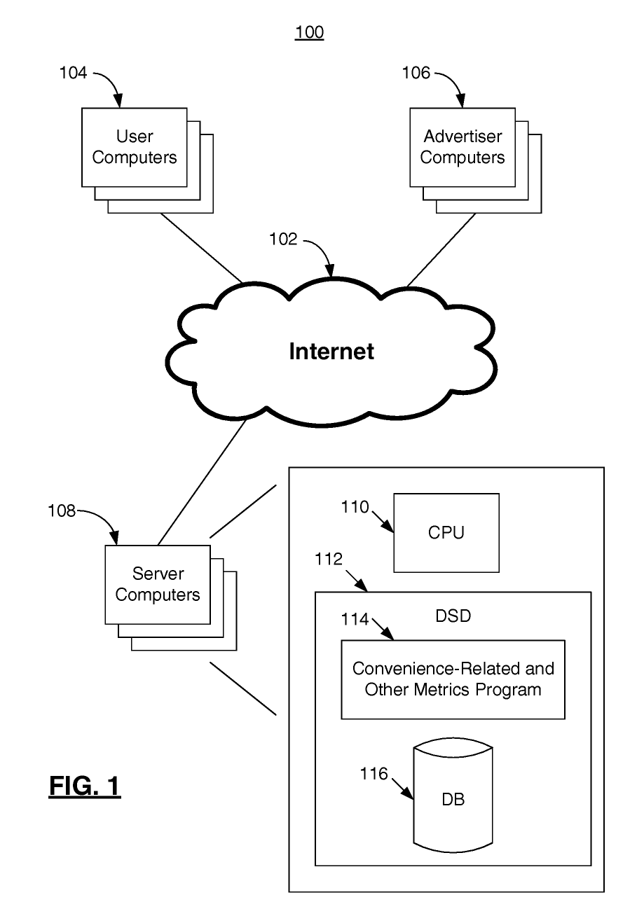

FIG. 1 is a distributed computer system 100 according to one embodiment of the invention. The system 100 includes user computers 104, advertiser computers 106 and server computers 108, all coupled or able to be coupled to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user computers or other computers may be or include wireless, portable, or handheld devices such as cell phones, smart phone, PDAs, tablets, etc.

Each of the one or more computers 104, 106, 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as well as keyword searching and advertising in a sponsored search context. Many types of advertisements are contemplated, including textual advertisements, rich advertisements, video advertisements, coupon-related advertisements, group-related advertisements, social networking-related advertisements, etc.

As depicted, each of the server computers 108 includes one or more CPUs 110 and a data storage device 112. The data storage device 112 includes a database 116 and a Convenience-Related and Other Metrics Program 114.

The Program 114 is intended to broadly include all programming, applications, algorithms, software and other and tools necessary to implement or facilitate methods and systems according to embodiments of the invention. The elements of the Program 114 may exist on a single server computer or be distributed among multiple computers or devices.

Herein, a “consumer” is intended to broadly include a possible or actual consumer. Furthermore, herein, a “store” is broadly intended to include any venue at which a product may be purchased. Still further, herein, an “advertiser” is intended to broadly be or include agents or advertisers, publishers, market-makers, stores, individuals, retailers, product or brand marketers, etc. Furthermore, herein the term “product” is broadly intended to include, for example, such things as, items, articles, etc as well as services, such as services purchased and/or performed at a particular store or store location.

Various embodiments of the invention are generally described with reference to electronic or online advertising. However, it is to be understood that some embodiments of the invention also relate to or include offline advertising, such as television or radio advertising, magazine or print advertising, physical advertising such as billboards, etc. Also, some embodiments of the invention include or incorporate both online and offline advertising, including embodiments in which, for example, electronic, digital or computerized advertising techniques are used in connection with offline advertising, etc.

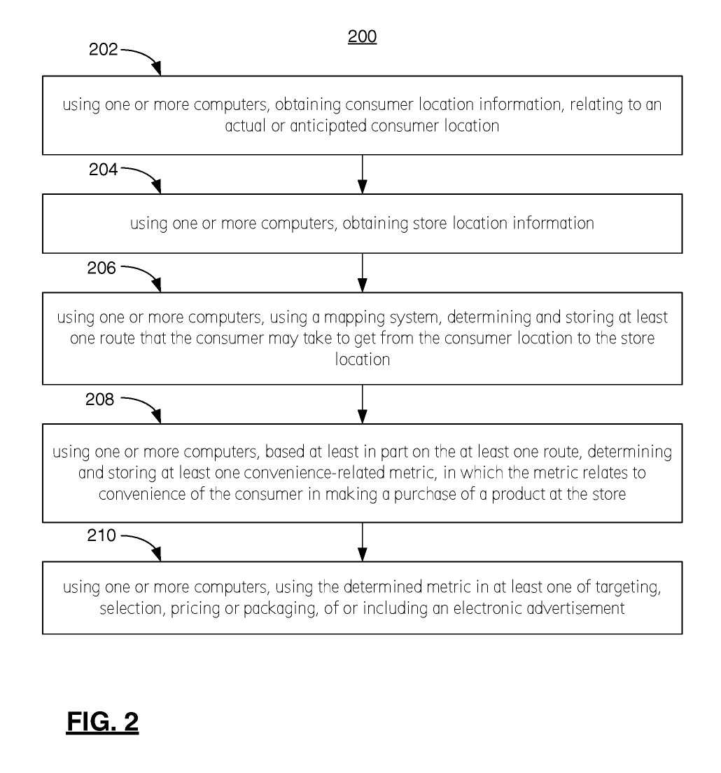

FIG. 2 is a flow diagram illustrating a method 200 according to one embodiment of the invention.

Step 202 includes, using one or more computers, obtaining consumer location information, relating to an actual or anticipated consumer location.

Step 204 includes, using one or more computers, obtaining store location information.

Step 206 includes, using one or more computers, using a mapping system, determining and storing at least one route that the consumer may take to get from the consumer location to the store location.

Step 208 includes, using one or more computers, based at least in part on the at least one route, determining and storing at least one convenience-related metric, in which the metric relates to convenience of the consumer in making a purchase of a product at the store. Such convenience can include simply the convenience of the consumer in getting to the store, or can include other convenience-related aspects.

Step 210 includes, using one or more computers, using the determined metric in at least one of targeting, selection, pricing or packaging, of or including an electronic advertisement, such as an online advertisement.

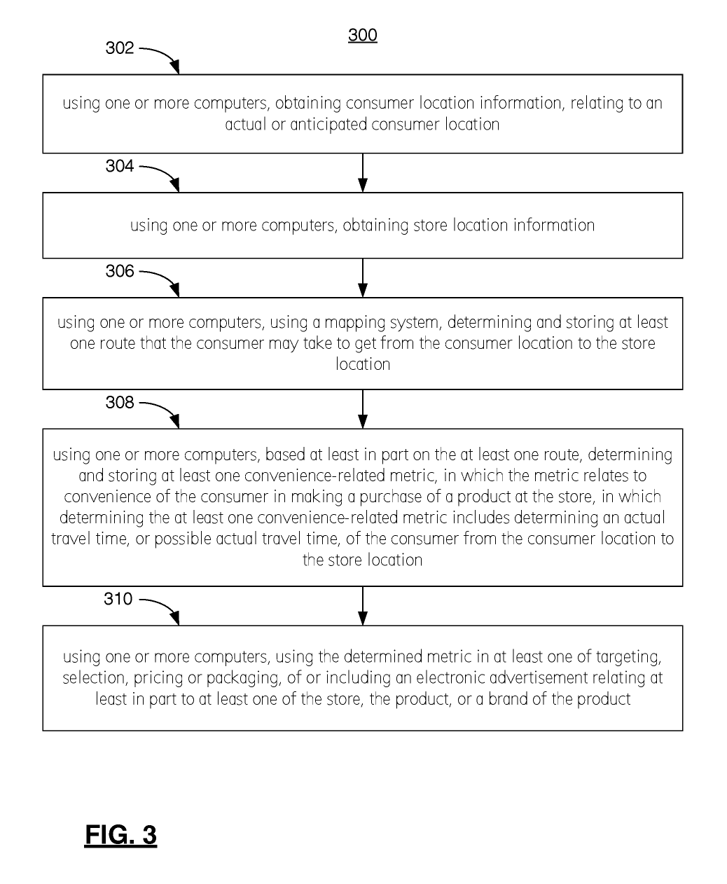

FIG. 3 is a flow diagram illustrating a method 300 according to one embodiment of the invention.

Steps 302, 304 and 306 are similar to steps 202, 204 and 206 of the method 200 depicted in FIG. 2.

Step 308 includes, using one or more computers, based at least in part on the at least one route, determining and storing at least one convenience-related metric, in which the metric relates to convenience of the consumer in making a purchase of a product at the store. Determining the at least one convenience-related metric includes determining an actual travel time, or possible actual travel time, of the consumer from the consumer location to the store location.

Step 310 includes, using one or more computers, using the determined metric in at least one of targeting, selection, pricing or packaging, of or including an electronic advertisement relating at least in part to at least one of the store, the product, or a brand of the product.

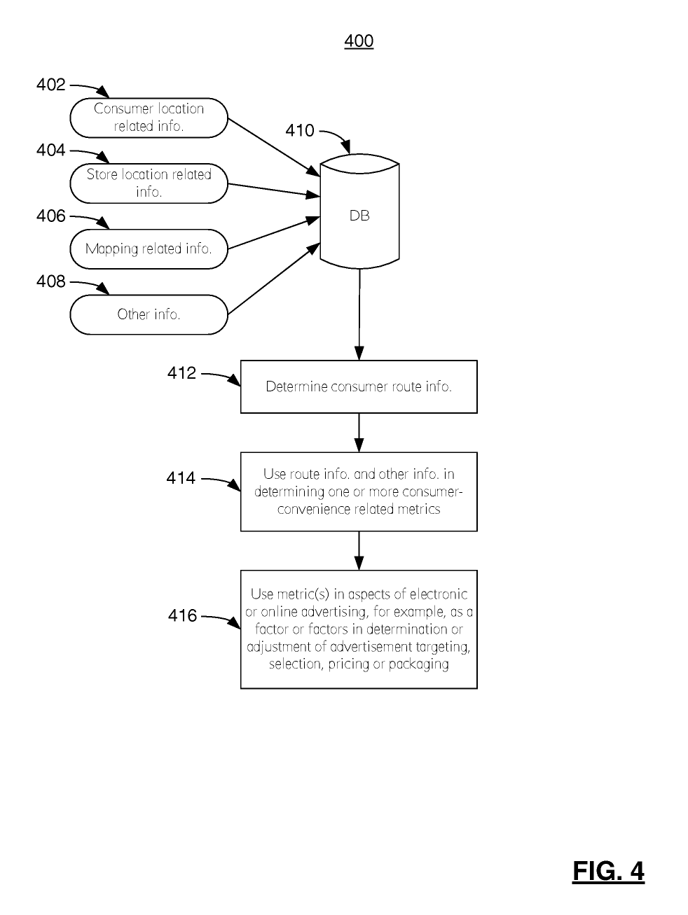

FIG. 4 is a block diagram 400 illustrating one embodiment of the invention. As depicted, various information is obtained and stored in one or more database, such as database 410. The information includes consumer location related information 402, store location related information 404, mapping related information 406, and may include other information 408.

At block 412, information from the database 410 is utilized in determining consumer route information.

At block 414, route information, and perhaps other information, is used in determining one or more consumer-convenience related metrics.

At block 416, the determined metric(s) are used in aspects of electronic or online advertising, for example, as a factor or factors in determination or adjustment of advertisement targeting, selection, pricing or packaging.

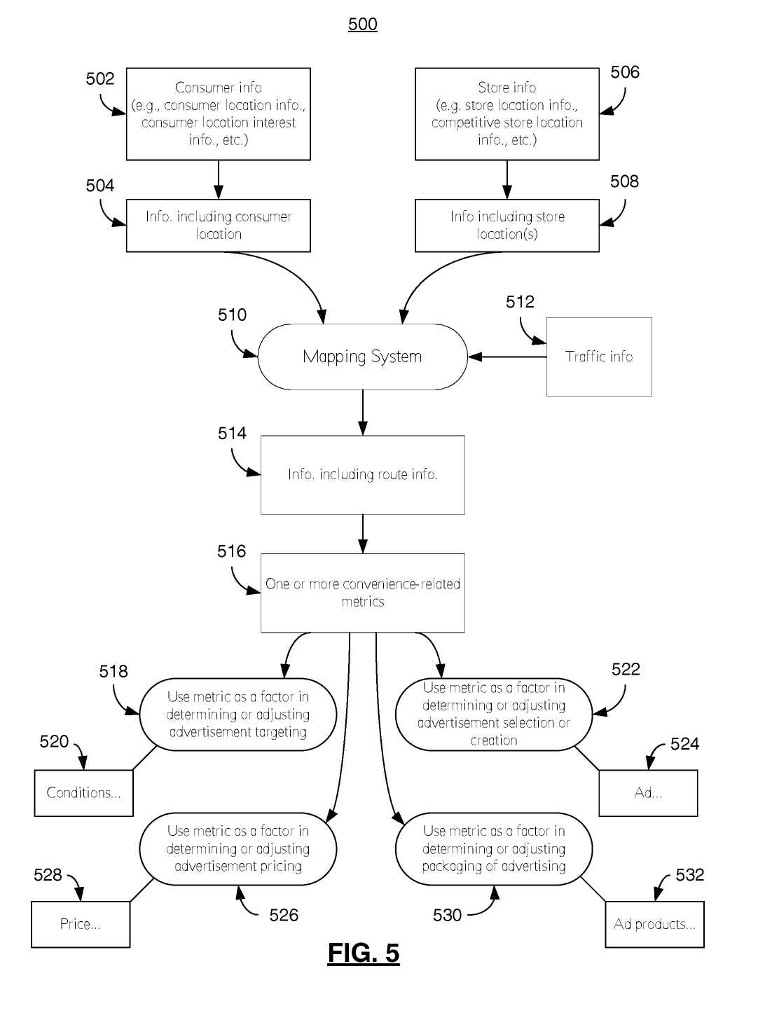

FIG. 5 is a block diagram 500 illustrating one embodiment of the invention.

Block 502 depicts determined or obtained consumer information, which may include consumer location information, consumer location interest information, and other information. Using this information, certain particular consumer location related information 504 is determined or obtained, including one or more consumer actual or anticipated consumer locations, and perhaps consumer location time information.

Block 506 depicts determined or obtained store information, which may include store location information, competitive store location information, and other information. Using this information, certain particular store location related information 508 is determined or obtained.

The particular consumer location related information 504 and the particular store location related information 508, which can include address information, and perhaps other location related information, as well as, in some embodiments, traffic related information 512, is used as input to a mapping system 510.

Block 514 includes determination of route information, which can include actual, anticipated, possible or likely consumer routes, and can include detailed information such as particular streets, roadways or bridges used, etc.

Block 516 includes determination of one or more convenience-related metrics, based at least in part on the route information. The convenience-related metrics can include, for example, determined consumer travel distance, consumer travel time, number or proximity of competitive stores, etc.

Blocks 518-530 depict use of the metric (or metrics) in various aspects of electronic or online advertising. Particularly, block 518 includes use of the metric as a factor in determining or adjusting advertisement targeting, such as in determining or adjusting targeting conditions 520. Block 522 depicts use of the metric as a factor in determining or adjusting selection or creation of an advertisement 524. Block 526 depicts use of the metric as a factor in determining or adjusting advertisement pricing or price 528. Block 530 depicts use of the metric as a factor in determining or adjusting packaging of advertising, which may be used in determining or adjusting aspects of combined advertising products 532 that may be provided or offered to advertisers, for example.

Some embodiments of the invention include determination and use of convenience-related metrics, such as travel-related convenience-related metrics, in various aspects of electronic or online advertising. Research shows that online advertising for retail stores prompts more sales from consumers who live or work near stores than from far away consumers. For example, being close to a store makes it easier for a consumer to walk in and buy. However, research also indicates that nearby consumers buy more online as well. For example, having a store nearby can build a consumer's awareness and trust of the brand, magnifying the power of advertising near stores. To take advantage of this effect using present technology, advertisers can, for example, target their ads based on geometric proximity (distance as the crow flies) or by pre-defined geographic regions such as country, state, zip code, zip+4, or DMA. Advertisers can, for example, select different ads to show to consumers with different distances, or approximate distances, by targeting different ads to different sets of pre-defined geographic regions. Publishers can, for example, set prices for opportunities to advertise based on labeled geographic regions. In online advertising, advertisers, publishers, and market-makers can benefit from expressing proximity between consumers and stores in ways that are functionally related to how easily consumers can access stores and hence how familiar consumers are likely to be with stores. Convenience-based distance metrics can, for example, go beyond pre-defined geographic regions, to account for factors such as travel distance to stores, travel time to stores, and relative distance to stores compared to distances to competitors' stores, for example.

Some embodiments of the invention include providing aspects of an online advertising marketplace that uses convenience-based metrics, such as in connection with distance between consumers and a retailer's stores. For example, some embodiments utilize determined travel distance, such as estimated travel distance, predicted travel distance, travel distance ranges, etc., along roads or other established routes (bridges, ferries, etc.) to the retailer's nearest store. Some embodiments utilize travel time, which can include approximate travel time, estimated travel time, predicted travel time, travel time ranges, etc., such as time required to travel to the retailer's nearest store. Such travel times may include consideration of factors such as road quality, speed limits, and, in some embodiments, current traffic conditions. Some embodiments take into account relative distance, such travel distance, or travel time, or geometric proximity to the retailer's nearest store, compared to distance to competitive retailers' nearest stores. Some embodiments include use of metrics that may indicate how convenient the retailer is compared to competitors. For example, the distance metric may be or include how many competitors' stores are closer to the consumer than the nearest store for the retailer.

Convenience-based distance or other metrics may be used in pricing, such as, for example, in connection with online publishers or market-makers determining how much to charge advertisers for opportunities to advertise. The metrics may also be used in targeting, such as in connection with advertisers selecting where to advertise or providing targeting conditions. Convenience-related metrics may also bused in packaging, such as in connection with publishers determining advertising opportunities to be sold together. The metrics may also be used in ad selection, such as in connection with determining which ads to show to which consumers.

Some embodiments of the invention include use of the following basic steps. First, consumer location data is obtained, which can include real-time location information. Next, store location data is obtained, for example, for a retailer who may be advertising. Next, a mapping system is used to determine the distance a consumer needs to travel to get to the nearest store, such as along roads or other established routes. Next, that determined travel distance is used as an input to pricing, packaging, targeting, and/or ad selection. To compute travel time, some embodiments include use of average travel time from the mapping system. Furthermore, some embodiments include obtaining and using current or real-time traffic conditions from a traffic system. In some embodiments, to compute relative distance, distance is computed to competitors' store locations and compared to the distance for the retailer's nearest store, or related metrics may be utilized.

In some embodiments, a consumer location can be, for example, where the consumer lives, works, or vacations. It can also be a location where the consumer rarely if ever visits but is a focus of interest. The location can be one where the consumer visits as a habit, or the consumer's current location. Sources of location data may include, for example, data from the consumer's internet service provider (ISP), real-time GPS data, data the consumer volunteers when registering with the publisher, the consumer's search or browsing history, or the consumer's smart phone, tablet computer, or other mobile electronic device.

Store location can be, for example, the retailer's store or outlet. Store location can also be a store where an advertiser's products are sold, even if the store does not share the advertiser's name. For example, the advertiser may produce its own brand of shoes, which is sold in a variety of retailers' stores. The store may also be an event or event venue where the advertiser's goods are sold, rather than a permanent location. Sources of store location data include, for example, the advertiser itself, online store locators, searching in mapping systems, and listings such as yellow pages, Internet searches, and others. Herein, various forms of advertisers are anticipated, such as advertisers associated with products, brands of products, stores, etc.

In some embodiments, a mapping system may, for example, take start and finish locations as inputs and may produce travel distances as outputs. The mapping system may also, for example, produce travel times, such as average travel times, travel times adjusted for time of day or week, or travel times given current traffic and weather conditions. An example mapping system powers maps.yahoo.com.

In some embodiments, a traffic system may supply current or real-time traffic conditions. An example traffic system powers sigalert.com.

In some embodiments, pricing may be for advertising opportunities and convenience-related metrics may be used in calculating or adjusting pricing. For example, a shorter travel distance or time may lead to a higher price and vice versa, or a short distance to a competitor store may lead to a higher price and vice versa, etc. Types of pricing include floor prices, reserve prices, spot prices, and future prices. Floor prices can be minimums, communicated to negotiators who are selling. Reserve prices can be minimum prices for a sale by auction. Spot prices can be for immediate delivery of advertising opportunities. Future prices can be for opportunities to be delivered at a specified time in the future. In some embodiments, convenience-based distance measures or metrics may be combined with other inputs to compute prices. Other inputs may include data on the consumer, such as demographic, geographic, or individual-level information, for example, from a consumer relationship management (CRM) system or a third-party data provider.

In some embodiments, publishers or market-makers may combine advertising opportunities to consumers near an advertiser's stores into packages for sale. Packages may also be based on proximity to competitors' stores. Packages may be based on other data in addition to convenience-based distance.

Targeting can include expressing conditions for an advertiser to buy at some price. For example, an advertiser may be willing to pay one amount for an opportunity to advertise to a consumer within a thirty minute drive of their store, but less if the consumer must drive more than thirty minutes. Furthermore, an advertiser may, for example, be willing to pay more if one or more competitor stores, or competitor stores that sell a particular product or brand, is a short travel distance from the consumer. Conditions may be expressed in terms of other information as well as convenience-based distance.

Convenience-based metrics may be used in ad selection, such as in determining which ad to show in response to an opportunity to advertise. For example, if the consumer is close to a store, the ad can include a call to action to shop in a store, but if the consumer is far from a store, the ad can include a call to action to shop online. Likewise, ads for nearby consumers can be designed to deepen a brand relationship, while ads for faraway consumers can be designed to pique interest and initiate a relationship.

While the invention is described with reference to the above drawings, the drawings are intended to be illustrative, and the invention contemplates other embodiments within the spirit of the invention.

1. A method comprising:
using one or more computers, obtaining consumer location information, relating to an actual or anticipated consumer location;
using one or more computers, obtaining store location information;
using one or more computers, using a mapping system, determining and storing at least one route that the consumer may take to get from the consumer location to the store location;
using one or more computers, based at least in part on the at least one route, determining and storing at least one convenience-related metric, wherein the metric relates to convenience of the consumer in making a purchase of a product at the store; and
using one or more computers, using the determined metric in at least one of targeting, selection, pricing or packaging, of or including an electronic advertisement.

2. The method of claim 1, comprising determining and storing at least one convenience-related metric, wherein the metric relates to convenience of the consumer in making a purchase of any product at the store.

3. The method of claim 1, comprising using the determined metric in at least one of targeting, selection, pricing or packaging, of or including an online advertisement relating at least in part to at least one of the store, the product, or a brand of the product.

4. The method of claim 1, wherein determining the at least one convenience-related metric comprises determining an actual travel distance, or possible actual travel distance, of the consumer from the consumer location to the store location.

5. The method of claim 1, wherein determining the at least one convenience-related metric comprises determining an actual travel time, or possible actual travel time, of the consumer from the consumer location to the store location.

6. The method of claim 1, wherein determining the at least one convenience-related metric comprises determining an actual travel time, or possible actual travel time, of the consumer from the consumer location to the store location, comprising utilizing traffic, traffic pattern or real-time traffic information.

7. The method of claim 1, wherein using a mapping system comprises using a GPS system.

8. The method of claim 1, wherein determining the at least one convenience-related metric comprises determining at least one travel distance from the consumer location to one or more locations of one or more other stores, wherein the one or more other stores at least in part compete with the store.

9. The method of claim 1, wherein obtaining consumer location information comprises obtaining information relating to a location at which the consumer lives, works, recreates, or has shown an interest in.

10. The method of claim 1, comprising obtaining the store location information, wherein the store may comprise a retail store, outlet, event venue, or other venue at or through which products may be purchased.

11. The method of claim 1, comprising obtaining consumer location information, wherein the consumer may be an actual consumer or potential consumer, and wherein the consumer can be a computer user, computerized device user, mobile electronic device user, cell phone user, smart phone user, PDA user, or tablet computer user.

12. The method of claim 1, comprising utilizing the at least one convenience-related metric as a factor in targeting an electronic advertisement to the consumer, and comprising serving the electronic advertisement to the user.

13. The method of claim 1, comprising utilizing the at least one convenience-related metric as a factor in pricing of advertising inventory.

14. The method of claim 1, using one or more computers, using the determined metric in electronic advertisement packaging, wherein packaging relates to serving, or an agreement to serve, multiple electronic advertisements sharing at least one common aspect.

15. A system comprising:
one or more server computers coupled to a network; and
one or more databases coupled to the one or more server computers;
wherein the one or more server computers are for:
obtaining consumer location information, relating to an actual or anticipated consumer location,
obtaining store location information;
using a mapping system, determining and storing at least one route that the consumer may take to get from the consumer location to the store location,
based at least in part on the at least one route, determining and storing at least one convenience-related metric, wherein the metric relates to convenience of the consumer in making a purchase of a product at the store; and
using the determined metric in at least one of targeting, selection, pricing or packaging, of or including an electronic advertisement.

16. The system of claim 15, comprising using the determined metric in at least one of targeting, selection, pricing or packaging, of or including an electronic advertisement relating at least in part to at least one of the store, the product, or a brand of the product.

17. The system of claim 15, wherein at least one of the one or more server computers are coupled to the Internet, and wherein the electronic advertisement is an online advertisement.

18. The system of claim 15, wherein determining the at least one convenience-related metric comprises determining a travel time of the consumer from the consumer location to the store location.

19. The system of claim 15, wherein the consumer is an actual or possible consumer, and wherein the consumer can be a computer user, computerized device user, mobile electronic device user, cell phone user, smart phone user, PDA user, or tablet computer user.

20. A computer readable medium or media containing instructions for executing a method comprising:
using one or more computers, obtaining consumer location information, relating to an actual or anticipated consumer location;
using one or more computers, obtaining store location information;
using one or more computers, using a mapping system, determining and storing at least one route that the consumer may take to get from the consumer location to the store location;
using one or more computers, based at least in part on the at least one route, determining and storing at least one convenience-related metric, wherein the metric relates to convenience of the consumer in making a purchase of a product at the store;
wherein determining the at least one convenience-related metric comprises determining an actual travel time, or possible actual travel time, of the consumer from the consumer location to the store location; and
using one or more computers, using the determined metric in at least one of targeting, selection, pricing or packaging, of or including an electronic advertisement relating at least in part to at least one of the store, the product, or a brand of the product.
